(19) United States
(12) Patent Application Publication
(10) Pub. No.: US 2022/0406064 A1
(43) Pub. Date: Dec. 22, 2022

(54) MONITORING SYSTEM, MONITORING METHOD, AND PROGRAM

(71) Applicant: JOHNAN Corporation, Uji-shi, Kyoto (JP)

(72) Inventors: Kozo MORIYAMA, Uji-shi (JP); Shin KAMEYAMA, Uji-shi (JP); Truong Gia VU, Uji-shi (JP); Lucas BROOKS, Uji-shi (JP)

(73) Assignee: JOHNAN Corporation, Uji-shi, Kyoto (JP)

(21) Appl. No.: 17/761,119

(22) PCT Filed: Sep. 29, 2020
(86) PCT No.: PCT/JP2020/036822

§ 371 Date: Mar. 16, 2022

(30) Foreign Application Priority Data
Sep. 30, 2019 (JP) 2019-179126

(51) Int. Cl. G06V 20/52; G06V 20/40; G06T 7/20; G01S 13/52

(52) U.S. Cl. CPC G06V 20/52; G06V 20/44; G06T 7/20; G01S 13/52; G06T 2207/30232

(57) ABSTRACT

A monitoring system for monitoring a monitoring area according to one or more embodiments may include a first sensor for detecting movement of a moving object in the monitoring area, a second sensor for determining entry and exit of a person in the monitoring area, and a control device connected to the first sensor and the second sensor. When the first sensor detects movement of the moving object, the control device is configured to determine entry and exit of a person in the monitoring area by referring to a detection result by the second sensor.

### TECHNICAL FIELD

The present invention relates to a monitoring system, a monitoring method, and a program.

### BACKGROUND ART

Conventional techniques have disclosed devices for monitoring the working environment of a robot (for example, see PTL 1).

A known device for monitoring the working environment of a robot is equipped with a camera for capturing an image of a work area of a robot (a monitoring area), and a computer for detecting a moving object by referring to a result of an image captured by the camera. On detection of a moving object that is approaching the robot, the computer is configured to issue a warning on a display and to handle the situation, for example, by stopping the robot.

### CITATION LIST

### Patent Literature

PTL 1: JP H05-261692 A

### SUMMARY OF INVENTION

### Technical Problem

To conduct the monitoring operation (determination of entry/exit of a person in the work area), however, the above-mentioned conventional working environment monitoring device constantly refers to the results of images captured by the camera while the robot is in operation. This monitoring operation increases the information processing load and hampers reduction of an operational cost.

The present invention is made to solve the above problem, and aims to provide a monitoring system, a monitoring method, and a program that can reduce the information processing load.

### Solution to Problem

A monitoring system according to the present invention monitors a monitoring area. The monitoring system includes a first sensor for detecting movement of a moving object in the monitoring area, a second sensor for determining entry and exit of a person in the monitoring area, and a control device connected to the first sensor and the second sensor. When the first sensor detects movement of the moving object, the control device is configured to determine entry and exit of a person in the monitoring area, by referring to a detection result by the second sensor.

While the first sensor does not detect movement of a moving object, this monitoring system does not use the second sensor to determine whether a person has entered or exited from the monitoring area. Compared with the case where entry and exit of a person in the monitoring area is constantly determined with use of the second sensor, this configuration can reduce the information processing load.

A monitoring method according to the present invention monitors a monitoring area. The monitoring method includes a step of detecting movement of a moving object in the monitoring area by a first sensor, a step of detecting the moving object by a second sensor when the first sensor detects movement of the moving object, and a step of determining entry and exit of a person in the monitoring area by a control device, by referring to a detection result by the second sensor.

A program according to the present invention causes a computer to implement a procedure for causing a first sensor to detect movement of a moving object in a monitoring area, a procedure for causing a second sensor to detect the moving object when the first sensor detects movement of the moving object, and a procedure for determining entry and exit of a person in the monitoring area by referring to a detection result by the second sensor.

### Advantageous Effects of Invention

The monitoring system, the monitoring method, and the program according to the present invention can reduce the information processing load.

### BRIEF DESCRIPTION OF DRAWINGS

FIG. 1 is a block diagram showing a general configuration of a robot control system according to the present embodiment.

FIG. 2 is a flowchart describing an operation of the robot control system according to the present embodiment.

FIG. 3 is a block diagram showing a general configuration of a robot control system according to a modified example of the present embodiment.

### DESCRIPTION OF EMBODIMENTS

An embodiment of the present invention is described below. In the following description, the monitoring system according to the present invention is applied to a robot control system.

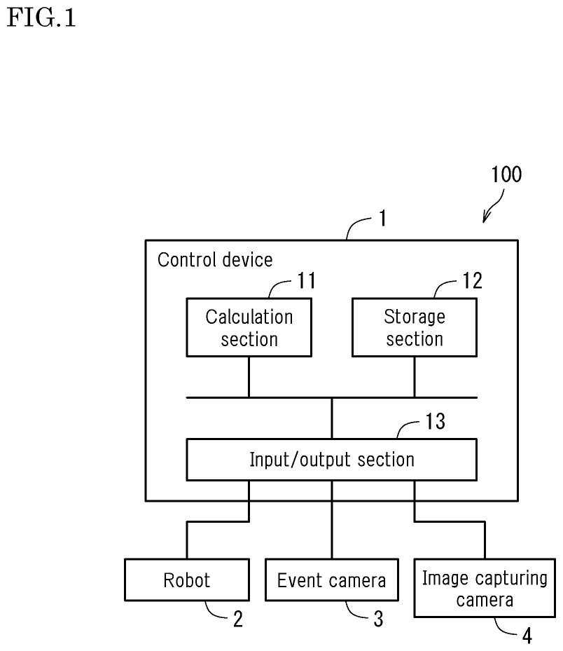

Referring to FIG. 1, a description is made of a configuration of a robot control system 100 according to an embodiment of the present invention.

The robot control system 100 is applied to a factory floor, for example, and is configured to cause a robot 2 to perform a predetermined task on the factory floor. This robot control system 100 does not separate the robot 2 by a fence or the like, and keeps a work area of the robot 2 accessible to a person. As shown in FIG. 1, the robot control system 100 includes a control device 1, the robot 2, an event camera 3, and an image capturing camera 4.

The control device 1 has a function of controlling the robot 2 and a function of monitoring a work area where the robot 2 performs a task. The control device 1 includes a calculation section 11, a storage section 12, and an input/output section 13. The calculation section 11 is configured to control the control device 1 by performing arithmetic processing based on programs and the like stored in the storage section 12. The storage section 12 stores a program for controlling the robot 2, a program for monitoring the work area where the robot 2 performs the task, and other like programs. The input/output section 13 is connected to the robot 2, the event camera 3, the image capturing camera 4, etc. The control device 1 possesses location information of the robot 2 that is performing the task. Note that the control device 1 is an example of “the computer” in the present invention.

The robot 2 is controlled by the control device 1 to perform a predetermined task. For example, the robot 2 has a multi-axis arm and a hand, and is configured to transport a workpiece. The hand, as an end effector, is provided at an extreme end of the multi-axis arm. The multi-axis arm serves to move the hand, and the hand serves to hold the workpiece. The work area of the robot 2 is an area surrounding the robot 2, and covers an area in which the robot 2 moves and the workpiece held by the robot 2 passes during the task. Note that the work area of the robot 2 is an example of “the monitoring area” in the present invention.

The event camera 3 serves to monitor the work area, and is configured to detect movement of a moving object (for example, a person) in the work area of the robot 2. The event camera 3 is configured to send out event information to the control device 1 when luminance in a camera view angle (in the work area) has changed (when an event has occurred). The event information contains the time of the luminance change (the timestamp on the occurrence of an event), coordinates of pixels at which the luminance has changed (the location of the event occurrence), and the direction of the luminance change (the polarity). The event camera 3, which captures a smaller amount of information than the image capturing camera 4, is highly responsive and consumes less power. In other words, the event camera 3 serves to detect a change in the state of the work area (for example, entry of a person into the work area) with high responsiveness at low power consumption. Note that the event camera 3 is an example of “the first sensor” in the present invention.

The image capturing camera 4 serves to monitor the work area, and is configured to capture an image of the work area of the robot 2. Specifically, the image capturing camera 4 serves to determine entry and exit of a person in the work area, and to calculate a distance D between the robot 2 and a person who has entered the work area. The image capturing camera 4 is configured to be activated when the event camera 3 detects movement of a moving object. The image capturing camera 4 is configured to be stopped when the event camera 3 does not detect movement of a moving object. The result of an image captured by the image capturing camera 4 is entered into the control device 1. Note that the image capturing camera 4 is an example of “the second sensor” in the present invention.

The control device 1 is configured to judge the state of the work area by referring to the inputs from the event camera 3 and the image capturing camera 4, and to cause the robot 2 to follow a normal process or an approach-handling process, depending on the state of the work area.

The normal process causes the robot 2 to perform a preset task repetitively. The approach-handling process also causes the robot 2 to perform a preset task repetitively, while keeping the distance D between the robot 2 and a person to avoid interference (collision) between the robot 2 and the person. For example, suppose that the robot 2 has a task of transporting a workpiece from a first location to a second location. In this task, the normal process causes the robot 2 to move along a preset movement path, whereas the approach-handling process changes the preset movement path and causes the robot 2 to move along the changed movement path. The changed movement path is set, for example, based on the position of the person or other like factors, such that the distance D is not less than a predetermined threshold Th. The predetermined threshold Th is defined in advance, and represents a separation distance between the robot 2 and a person (a critical allowable approach distance between the robot 2 and the person).

When the state of the work area has not changed, the control device 1 is configured to operate in the following manner. To be specific, the state of the work area has not changed in a case where the event camera 3 does not detect movement of a moving object in the work area, and in a case where the event camera 3 has detected movement of a moving object in the work area but the detected moving object is determined as the robot 2. In these cases, the control device 1 is configured to cause the robot 2 to follow the normal process, with the image capturing camera 4 stopped.

When the state of the work area may have changed (for example, a person may have entered the work area), the control device 1 is configured to operate in the following manner. To be specific, the state of the work area may have changed in a case where the event camera 3 has detected movement of a moving object in the work area and the detected moving object is determined as something other than the robot 2. In this case, the control device 1 is configured to activate the image capturing camera 4. The control device 1 is further configured to determine whether a person has entered the work area, by referring to the result of an image captured by the image capturing camera 4. On determining that a person has entered the work area, the control device 1 is configured to calculate the distance D between the robot 2 and the person, by referring to the result of the image captured by the image capturing camera 4. In other words, when the control device 1 has detected a possible change in the state of the work area by referring to the detection result by the event camera 3, the control device 1 is configured to proceed to image processing of the result of the image captured by the image capturing camera 4 and thereby to grasp an exact state of the work area. It should be noted, however, that image processing of the result of an image captured by the image capturing camera 4 imposes a heavy information processing load. Hence, the image capturing camera 4 and the relevant image processing are stopped while the control device 1 referring to the detection result by the event camera 3 determines that the state of the work area has not been changed.

The control device 1 is configured to cause the robot 2 to follow the normal process if the distance D is not less than the predetermined threshold Th, and to cause the robot 2 to follow the approach-handling process if the distance D is less than the predetermined threshold Th. This configuration ensures the separation distance between the robot 2 and the person.

### —Operation of the Robot Control System—

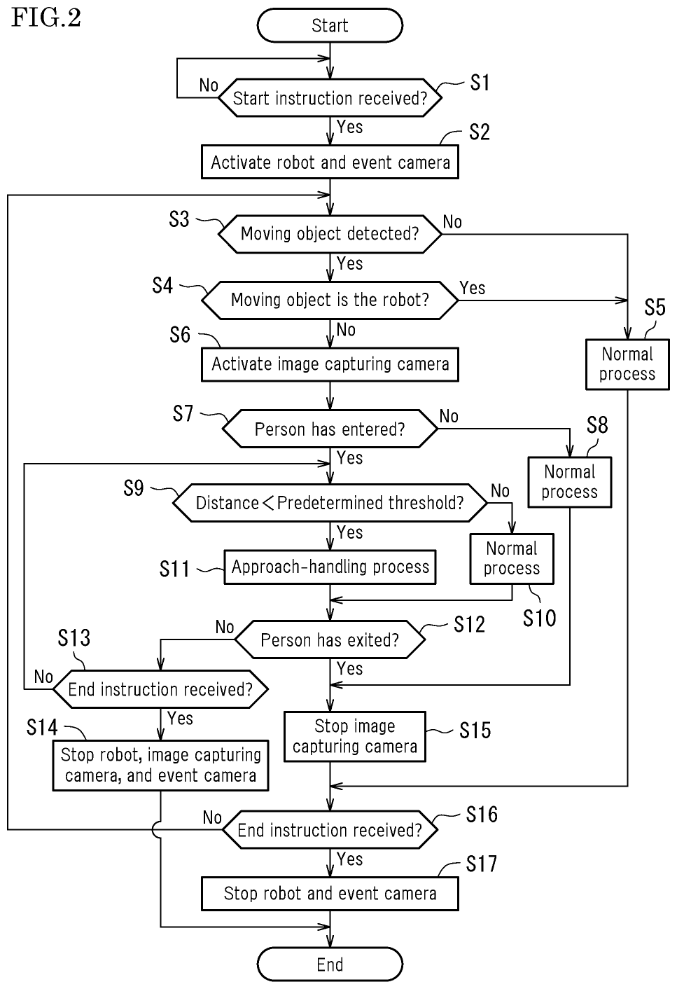

Referring next to FIG. 2, a description is made of an operation of the robot control system 100 according to the present embodiment. The following steps are performed by the control device 1.

In step S1 in FIG. 2, the control device 1 determines whether it has received an instruction to start the task by the robot 2. If the control device 1 has received an instruction to start the task, the process goes to step S2. On the other hand, if the control device 1 has not received an instruction to start the task, step S1 is repeated. In other words, the control device 1 is on standby until it receives an instruction to start the task.

In step S2, the control device 1 activates the robot 2 and the event camera 3. Specifically, the robot 2 performs a predetermined initialization process, and the event camera 3 starts monitoring of the work area.

In step S3, the control device 1 determines whether the event camera 3 has detected movement of a moving object in the work area. Specifically, an input of event information from the event camera 3 is determined as detection of movement of a moving object, and no input of event information from the event camera 3 is determined as no detection of movement of a moving object. When movement of a moving object is not detected, namely, when the state of the work area has not changed, the process goes to step S5, where the normal process is conducted (the robot 2 performs the task on the preset movement path), and then proceeds to step S16. On the other hand, when movement of a moving object is detected, the process goes to step S4.

In step S4, the control device 1 determines whether the moving object detected by the event camera 3 is the robot 2. For example, if the location information (the actual position) of the robot 2 possessed by the control device 1 matches the event occurrence location contained in the event information, the moving object is determined as the robot 2. If the location information of the robot 2 possessed by the control device 1 does not match the event occurrence location contained in the event information, the moving object is determined as something other than the robot 2. When the moving object is determined as the robot 2, namely, when the state of the work area has not changed, the process goes to step S5, where the normal process is conducted (the robot 2 performs the task on the preset movement path), and then proceeds to step S16. On the other hand, when the moving object is determined as something other than the robot 2, namely, when the state of the work area may have changed, the process goes to step S6.

In step S6, the image capturing camera 4 is activated. In other words, the image capturing camera 4 starts monitoring of the work area.

In step S7, the control device 1 determines whether a person has entered the work area, by applying image processing to the result of an image captured by the image capturing camera 4. If the control device 1 determines that no person has entered the work area, the process goes to step S8, where the normal process is conducted (the robot 2 performs the task on the preset movement path), and then proceeds to step S15. Incidentally, there is a case where a detected moving object is determined as something other than the robot 2, but the result of image analysis indicates that no person has entered the work area. Such a determination may occur when a change in brightness in the work area is incorrectly detected as a moving object. On the other hand, when the result of image analysis indicates that a person has entered the work area, the process goes to step S9.

In step S9, the control device 1 calculates the distance D between the robot 2 and the person, by applying image processing to the result of an image captured by the image capturing camera 4. Then, the control device 1 determines whether the distance D is less than the predetermined threshold Th. If the distance D is determined as not less than the predetermined threshold Th (if the distance D is equal to or greater than the predetermined threshold Th), the process goes to step S10, where the normal process is conducted (the robot 2 performs the task on the preset movement path), and then proceeds to step S12. On the other hand, if the distance D is determined as less than the predetermined threshold Th, the process goes to step S11, where the approach-handling process is conducted (the robot 2 performs the task on the changed movement path), and then proceeds to step S12.

In step S12, the control device 1 determines whether the person has exited the work area, by applying image processing to the result of an image captured by the image capturing camera 4. If the control device 1 determines that the person has not exited from the work area, the process goes to step S13. On the other hand, if the control device 1 determines that the person has exited from the work area, the process goes to step S15.

In step S13, the control device 1 determines whether it has received an instruction to end the task by the robot 2. If the control device 1 has received an instruction to end the task, the robot 2, the event camera 3, and the image capturing camera 4 are stopped in step S14, and the process goes to End. On the other hand, if the control device 1 has not received an instruction to end the task, the process returns to step S9.

In step S15, the image capturing camera 4 is stopped. In other words, the image capturing camera 4 stops monitoring of the work area, and the event camera 3 resumes monitoring of the work area.

In step S16, the control device 1 determines whether it has received an instruction to end the task by the robot 2. If the control device 1 has received an instruction to end the task, the robot 2 and the event camera 3 are stopped in step S17, and the process goes to End. On the other hand, if the control device 1 has not received an instruction to end the task, the process returns to step S3.

### —Advantageous Effects—

In the present embodiment described above, when the event camera 3 detects movement of a moving object, the image capturing camera 4 is activated to conduct image processing and thereby to grasp an exact condition of the work area of the robot 2. On the other hand, when the event camera 3 does not detect movement of a moving object, the image capturing camera 4 is stopped so as to withhold determination of the state of the work area by image processing. In other words, this embodiment decides whether to determine an exact state of the work area, by referring to the detection result by the event camera 3 that captures a smaller amount of information. When it is necessary to determine an exact state of the work area, the image capturing camera 4 is activated to conduct image processing. To summarize, the work area is monitored first by the event camera 3 that imposes a smaller information processing load. When the event camera 3 detects movement of a moving object, the work area is monitored next by the image capturing camera 4 that imposes a greater information processing load. The monitoring by the image capturing camera 4 enables determination of an exact state of the work area. Compared with constant monitoring of the work area by the image capturing camera 4 (where image processing is applied to determine the state of the work area), the as-needed monitoring by the image capturing camera 4 can reduce the information processing load, and can eventually reduce the operational cost of the robot control system 100.

Besides, when the event camera 3 detects movement of a moving object in the work area but the detected moving object is determined as the robot 2, the present embodiment continues the monitoring by the event camera 3 and keeps the image capturing camera 4 stopped. During the monitoring of the work area by the event camera 3, the robot 2 that is performing the task in the work area can thus be excluded from a detection target. This embodiment can prevent unnecessary activation of the image capturing camera 4 due to the motion of the robot 2.

Further, when the present embodiment refers to the result of an image captured by the image capturing camera 4 and determines that no person has entered the work area, the present embodiment stops the image capturing camera 4 to end the monitoring by the image capturing camera 4, and resumes the monitoring by the event camera 3. This embodiment can eventually reduce the information processing load.

Further, when the present embodiment refers to the result of an image captured by the image capturing camera 4 and determines that the person has exited the work area, the present embodiment stops the image capturing camera 4 to end the monitoring by the image capturing camera 4, and resumes the monitoring by the event camera 3. This embodiment can eventually reduce the information processing load.

### Other Embodiments

The embodiment disclosed herein is considered in all respects as illustrative and should not be any basis of restrictive interpretation. The scope of the present invention is therefore indicated by the appended claims rather than by the foregoing embodiment alone. The technical scope of the present invention is intended to embrace all variations and modifications falling within the equivalency range of the appended claims.

For example, the above embodiment mentions, but is not limited to, the example of applying the present invention to the robot control system 100 that monitors the work area of the robot 2. Alternatively, the present invention may be applied to a monitoring system that monitors a monitoring area other than a work area of a robot.

The above embodiment mentions, but is not limited to, the example of including the control device 1 that has the function of controlling the robot 2 and the function of monitoring the work area where the robot 2 performs the task. Alternatively, the embodiment may separately include a control device for controlling a robot and a monitoring system for monitoring a work area where the robot performs a task.

The above embodiment mentions, but is not limited to, the example of including the event camera 3 and the image capturing camera 4. Alternatively, the embodiment may include a single camera having the function of an event camera and the function of an image capturing camera.

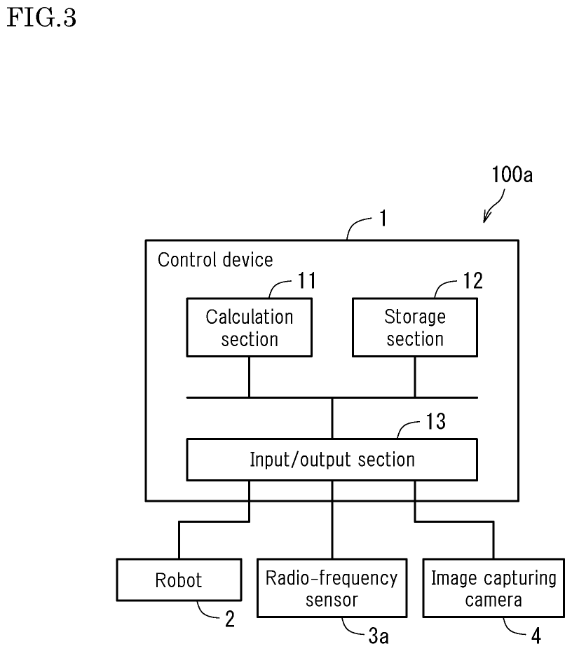

The above embodiment mentions, but is not limited to, the example of including the event camera 3 in the robot control system 100. Alternatively, referring to the modified example shown in FIG. 3, a robot control system 100a may include a radio-frequency sensor 3a instead of an event camera. The radio-frequency sensor 3a serves to detect movement of a person (a moving object) in the work area. The radio-frequency sensor 3a has a transmission section that transmits radio waves, and a receiving section that receives reflected waves when the radio waves transmitted from the transmission section are reflected by a person. The radio-frequency sensor 3a is configured to calculate the location of the person by referring to the results of such transmission and reception. The radio-frequency sensor 3a also serves to detect a change in the state of the work area (for example, entry of a person into the work area) with high responsiveness at low power consumption. Note that the radio-frequency sensor 3a is an example of “the first sensor” in the present invention.

The above embodiment mentions, but is not limited to, the example of including the image capturing camera 4. Alternatively, the image capturing camera may be replaced with a coordinate measuring machine that is configured to measure the three-dimensional geometry of the work area. The coordinate measuring machine serves to determine entry and exit of a person in the work area and to calculate the distance between the robot and a person who has entered the work area. The information processing load of the coordinate measuring machine is greater than that of an event camera. In this case, the work area is monitored first by the event camera that imposes a smaller information processing load. When the event camera detects movement of a moving object, the work area is monitored next by the coordinate measuring machine that imposes a greater information processing load. The monitoring by the coordinate measuring machine enables determination of an exact state of the work area. Compared with constant monitoring of the work area by the coordinate measuring machine, the as-needed monitoring by the coordinate measuring machine can reduce the information processing load. Note that the coordinate measuring machine is an example of “the second sensor” in the present invention.

The above embodiment mentions, but is not limited to, the example of activating the image capturing camera 4 when movement of a moving object is detected. Alternatively, the image capturing camera may be kept in a standby state and may be called back from the standby state when movement of a moving object is detected (the standby state may be cancelled to bring the image capturing camera back to the activated state). Further alternatively, the image capturing camera may be activated in advance, in which case image processing based on the result of a captured image (for example, image processing for determination of entry and exit of a person in the work area) may be conducted only when movement of a moving object is detected.

The above embodiment mentions, but is not limited to, the example of the approach-handling process that changes the movement path of the robot 2. Alternatively, the approach-handling process may include at least either reducing the movement speed of a robot or stopping the movement of a robot.

The above embodiment may be also arranged to stop the event camera 3 while the image capturing camera 4 is in operation.

The above embodiment mentions, but is not limited to, the example of causing the robot 2 to transport a workpiece. Alternatively, the robot may process the workpiece or handle the workpiece otherwise. In other words, the above embodiment mentions, but is not limited to, the example of the robot 2 equipped with the multi-axis arm and the hand. Alternatively, any robot structure is possible.

### INDUSTRIAL APPLICABILITY

The present invention is applicable to a monitoring system, a monitoring method, and a program for monitoring a monitoring area.

### REFERENCE SIGNS LIST

1 control device (computer)
2 robot
3 event camera (first sensor)
3a radio-frequency sensor (first sensor)
4 image capturing camera (second sensor)
100, 100a robot control system (monitoring system)

1. A monitoring system for monitoring a monitoring area, comprising:
a first sensor for detecting movement of a moving object in the monitoring area;
a second sensor for determining entry and exit of a person in the monitoring area; and
a control device connected to the first sensor and the second sensor,
wherein, when the first sensor detects movement of the moving object, the control device is configured to determine entry and exit of a person in the monitoring area, by referring to a detection result by the second sensor.

2. A monitoring method for monitoring a monitoring area, comprising:
detecting movement of a moving object in the monitoring area by a first sensor;
detecting the moving object by a second sensor when the first sensor detects movement of the moving object; and
determining entry and exit of a person in the monitoring area by a control device, by referring to a detection result by the second sensor.

3. A non-transitory computer-readable medium storing a program, which when read and executed, a computer to perform operations comprising:
causing a first sensor to detect movement of a moving object in a monitoring area;
causing a second sensor to detect the moving object when the first sensor detects movement of the moving object; and
determining entry and exit of a person in the monitoring area by referring to a detection result by the second sensor.
